(19) United States
(12) Patent Application Publication
(10) Pub. No.: US 2020/0085670 A1
(43) Pub. Date: Mar. 19, 2020

(54) Soft Tissue Mobilization Instrument

(71) Applicant: Carl R. Hanson, Medford, OR (US)

(72) Inventor: Carl R. Hanson, Medford, OR (US)

(21) Appl. No.: 16/691,594

(22) Filed: Nov. 21, 2019

Related U.S. Application Data
(63) Continuation-in-part of application No. 15/406,709, filed on Jan. 14, 2017.

(51) Int. Cl. A61H 7/00; A61H 1/00

(52) U.S. Cl. CPC A61H 7/003; A61H 2201/1253; A61H 1/008

(57) ABSTRACT

A unitary manipulation instrument for use by a practitioner on soft tissue of a person formed of a pair of planar sections, each section including an outer tissue engaging surface. The sections are interconnected and each section is located in a different spatial plane such that the sections are oriented at 90 degrees one with respect to the other.

### RELATED APPLICATIONS

The present application is a continuation-in-part of application Ser. No. 15/406,709 filed Jan. 14, 2017 for SOFT TISSUE MOBILIZATION INSTRUMENT.

### BACKGROUND OF THE INVENTION

The present invention relates to hand held tools and in particular to an instrument for the mobilization and treatment of human body soft tissue.

Soft tissue therapy is performed on an athlete or similar active individual by a trainer or bodyworker. Typically, the soft tissue such as muscles, tendons, fascia or ligaments reacts or breaks down after strenuous exercise, overuse or training or as a result of an injury. During a recovery or healing process, this tissue often causes fibrous adhesions or scar tissue with limited flexibility that ultimately will affect the individual's use of the injured area thereby impacting performance or just the well-being of the person. Repair of these areas may be done using the hands and fingers of a practitioner trained in the art of physical, soft tissue therapy, including various massage and deep tissue massage as well as cross frictional massage and rolfing. Using hands-on techniques to manipulate and mobilize the soft tissue often results in difficulty in applying the appropriate amount of pressure to achieve the desired result. Too little pressure will result in insufficient healing and too much pressure can result in additional injury.

To overcome this shortcoming in the soft tissue healing arts, a wide variety of tools and instruments have been developed for use by healthcare practitioners, physical therapists, occupational therapists, chiropractors and massage therapists to treat areas of soft tissue restriction and degeneration. These tools are used to break down fascial restrictions, including fascial adhesions and scar tissue, allowing for the return of normal movement of the muscle, ligament, tendon and/or joints. This technique enhanced and supported by an assisted soft tissue mobilization instrument promotes healing by increasing blood flow to the area of restriction, which, in turn, promotes an increase of nutrients flowing into and waste products flowing out of the degenerated tissue area.

These prior art instruments are generally shaped to match the particular shape of the soft tissue being treated. These tools have various curved surfaces including round, arcuate and parabolic shaped soft tissue engaging surfaces that enable a practitioner to apply essentially even pressure across the particular area being treated to break-up and loosen the fibrous and other material sought to be eliminated.

Prior art patents and applications showing prior art of interest include U.S. Pat. Nos. 5,366,437, 6,077,239, and 5,441,478 to Graston, U.S. Pat. No. 4,483,328, to Lin, D 696,414 to Hayami, D 686,333 to Innes, D 678,539 to Narson, D 645,568 to Walker, D 638,549 and D 634,022 to Scappaticci, 2015/0265486 to Fiore, 624,193, to Katzenberger, U.S. Pat. No. 6,077,239 to Lin, U.S. Pat. No. 5,441,478 to Courtin, D 675,332 to Tinder, U.S. Pat. No. 4,590,926 to Wolocko, and 2004/0249324 and 2006/0293619 to Louis.

Whereas the soft tissue engaging surfaces of these tools typically are well designed to engage the soft tissue, the overall shape of the tool is often awkward to handle requiring the practitioner to constantly grip and re-grip to tool in order to use it to maximum potential. Typically, the prior art tools have a variety of shapes in a single spatial plane making gripping by a practitioner difficult particularly when hard to access areas of the body need treatment.

### SUMMARY OF THE INVENTION

The present invention relates to a soft tissue mobilization instrument preferably having two inter-connected, soft tissue working sections for engaging and treating an area on the body of the person being treated that are designed for precise and even engagement of treatment pressure during treatment. A first of the working sections is located in a first spatial plane at a first angle and a second of said working sections is located in a second spatial plane at a second angle. The sections are connected at a 90 degree angle. Each working section is defined by length and width where the length of the section is approximately three times the width of the section. When one of the working sections is used for a treatment, the opposite working section preferably is used as a gripping area. The 90 degree relationship between the sections facilitate the use of one first section to engage the soft tissue of a person being treated while the practitioner grips the other second section in order to locate the working, soft tissue engagement surface in a precise and comfortable position so the soft tissue mobilization movements can be easily performed with essentially no manipulation of the instrument during the process. The section used for gripping is sufficiently spaced from the edge of the working section where lubricant is normally applied thereby eliminating the gripping problems of more conventional tools where the lubricant is applied adjacent the area that is gripped during use.

The two generally flat, planar sections of the instrument each include an outer shaped, tissue engaging surface for treatment of the tissue and upper and lower ends. An inner side of each section connects the sections together at the 90 degree angle when viewed from either end of the instrument.

The working, tissue engaging surfaces of each section at the outer edges of a section may assume a variety of different shapes that engage the treatment areas. For example, a section may have an outer edge that is curved and may be either slightly concave or convex. Preferably, each of the two sections will have a different shaped outer tissue engaging edge allowing a variety of treatment options depending on which procedure is used to engage the soft tissue of the individual being treated.

The 90 degree angle between the working sections of the instrument of the present invention provides a shape that allows one section to be used for an improved grip by the practitioner, particularly when working in and around the curves and nooks of the body while the opposite complementary section engages the person being treated.

A preferred instrument in accordance with the present invention is made of solid, heavy, polished metal such as stainless steel or the like thereby having significant weight that enhances the practitioner's ability to apply pressure to the treated tissue and also feel the depth of the soft tissue restrictions in the large fibrous areas of the body, such as the planter surface of the foot, IT band and the hamstring tendon.

The present invention includes various embodiments of the instrument whereby the gripping areas and the tissue engaging, working areas may be altered and/or interchanged to fit particular body shapes such by altering the size and shape of the edge of the working sections that engage the soft tissue of the person being treated. Typically, the tissue engaging edges are curved and may be concave or convex in overall shape.

An alternate embodiment is formed with a tissue engaging edge of at least one of the working sections of the instrument of a pair of parabolic shapes closely located and having an opening therebetween whereby the tissue being treated can be positioned between the parabolic shapes to facilitate treatment.

Among the objects of the present invention is the provision of a soft tissue mobilization instrument that is used by a health care practitioner to manipulate and mobilize the soft tissue of an individual.

Another object is the provision of a soft tissue mobilization instrument that is easy to hold by a practitioner during a treatment of the soft tissue of an individual.

Still another object is the provision of a soft tissue mobilization instrument that promotes healing in an area of restriction of the soft tissue of an individual by promoting blood flow in the soft tissue.

These and other objects will become apparent with reference to the following detailed description and drawings.

### DESCRIPTION OF THE DRAWINGS

FIG. 1 is a front perspective view of an embodiment of a soft tissue mobilization instrument of the present invention.

FIG. 2 is a front elevational view of the instrument of FIG. 1.

FIG. 3 is a front elevational view of the instrument of FIG. 1 taken at a 90 degree angle from the view of FIG. 2.

FIG. 4 is an end view of FIG. 1.

FIG. 5 is a perspective view showing a use position of the instrument of FIG. 1.

FIG. 6 is a front perspective view of another embodiment of a soft tissue mobilization instrument of the present invention.

FIG. 7 is a front elevational view of the instrument of FIG. 6.

FIG. 8 is a front elevational view of the instrument of FIG. 6 taken at a 90 degree angle from the view of FIG. 2.

FIG. 9 is an end view of FIG. 6.

FIG. 10 is a perspective view showing a use position of the instrument of FIG. 6.

FIG. 11 is a perspective view showing a second use position of the instrument of FIG. 6.

FIG. 12 is a front perspective view of still another embodiment of a soft tissue mobilization instrument of the present invention.

FIG. 13 is a front elevational view of the instrument of FIG. 12.

FIG. 14 is a front elevational view of the instrument of FIG. 12 taken at a 90 degree angle from the view of FIG. 13.

FIG. 15 is an end view of FIG. 12.

FIG. 16 is a perspective view showing a use position of the instrument of FIG. 12.

### DESCRIPTION OF THE PREFERRED EMBODIMENTS

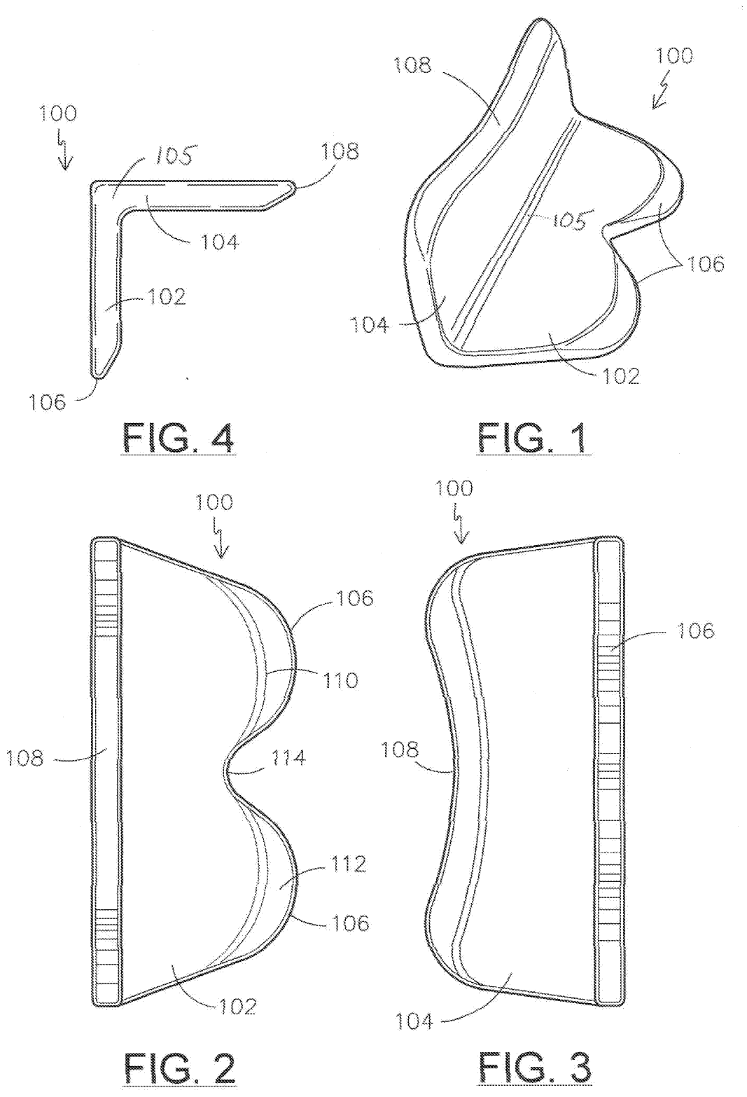

Referring to the drawings, FIGS. 1-5 illustrate a preferred embodiment of the soft tissue mobilization instrument 100. The instrument 100 is formed in two sections 102 and 104. Planar section 102 is generally flat and is located in a first spatial plane at a first angle. Planar section 104 is also generally flat and is located in a second spatial plane at a second angle that is 90 degrees to the first angle of the first section 102. The sections 102 and 104 are joined together forming a solid connection 105 along their respective inner longitudinal edges in order to maintain the 90 degree relationship between the sections 102 and 104. Section 102 includes edges 103a and 103b that define the width of the section 102 at the ends thereof. Similarly, section 104 includes edges 107a and 107b at the opposite ends of the section 104 that define the width thereof.

The first section 102 has a pair of generally parabolic, soft tissue engaging surfaces 106 shaped for engagement of a specific shaped injured area of a person being treated. For example, the space between the parabolic surfaces 106 allows the instrument to be used on narrow portions of the human body, such as the wrist or ankle parts that are thinner than the larger areas of the arms, legs and back.

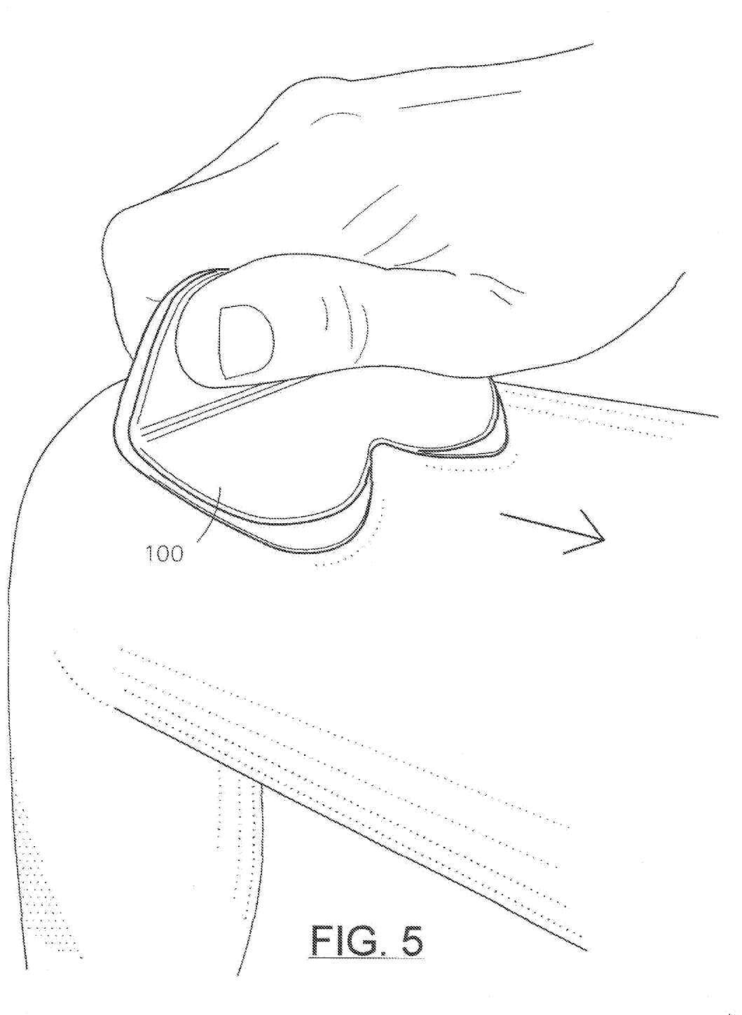

Section 104 of the instrument 100 includes another outer, curved tissue engaging surface 108 configured in a slight concave shape. It will be appreciated that either section 102 or 104 may be used to engage the tissue being treated. When one of the sections engages the tissue, the opposite section disposed at 90 degrees is used by the practitioner to grip the instrument 100 as seen with reference to FIG. 5.

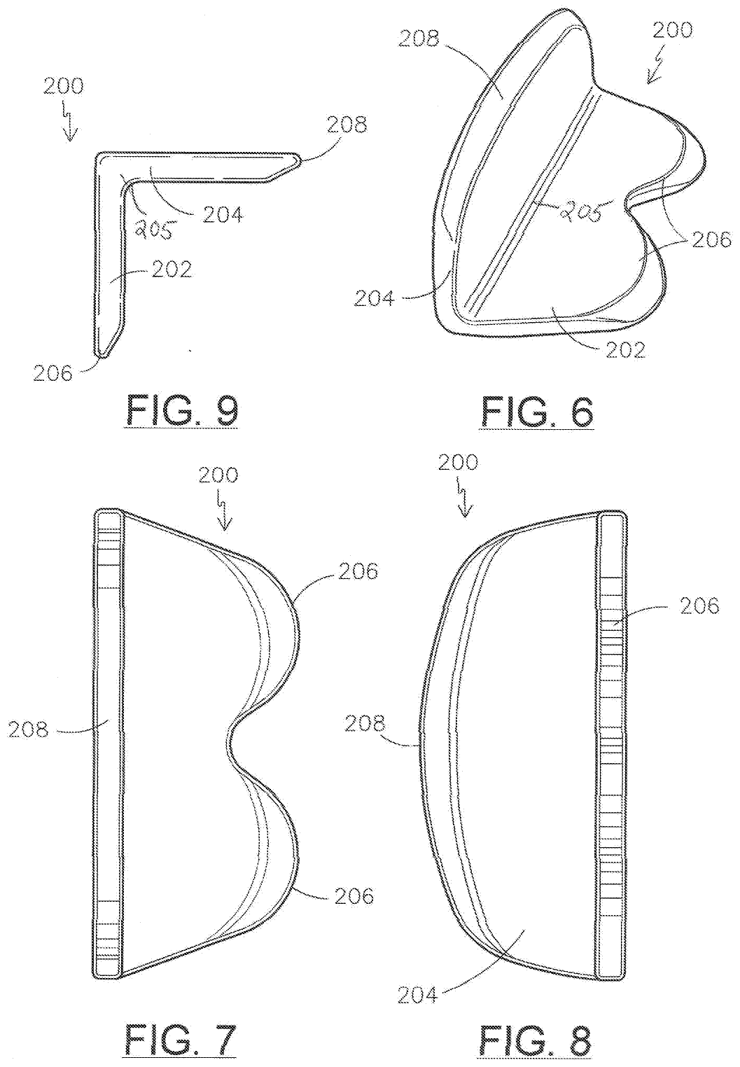

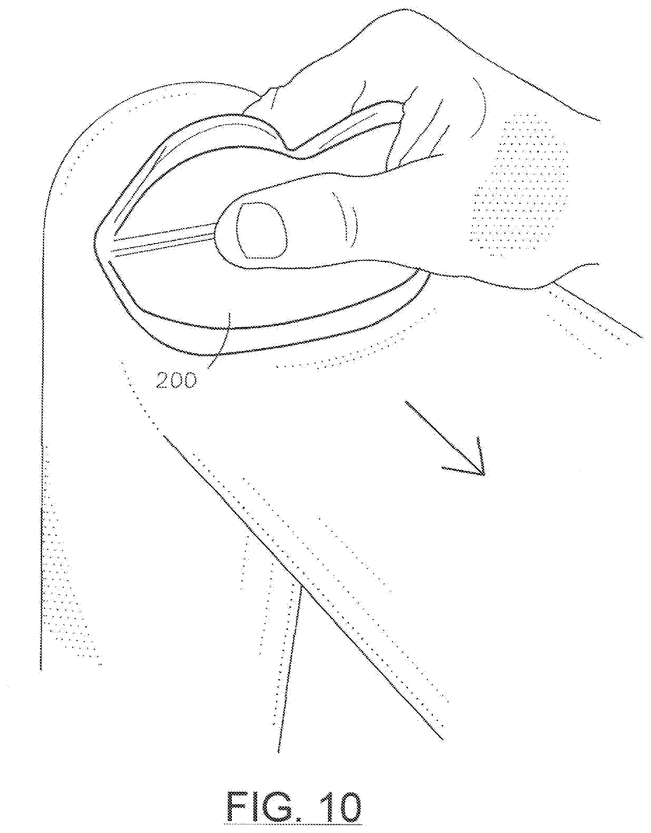

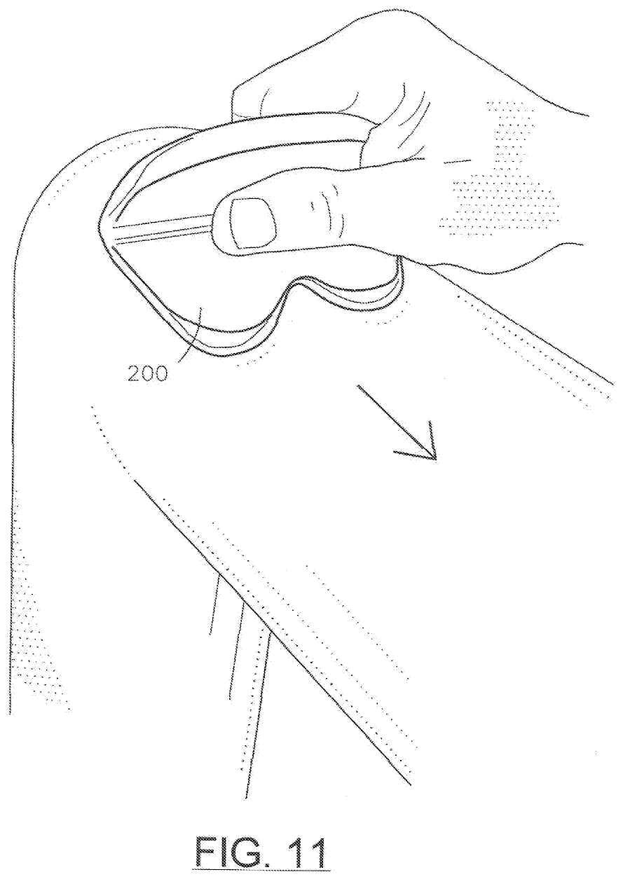

FIGS. 6 to 9 illustrate another embodiment of a soft tissue mobilization instrument 200. Similar to the first embodiment of FIGS. 1-4, instrument 200 includes sections 202 and 204 connected at 90 degrees along common, inner longitudinal edges 205. Section 202 includes parabolic tissue engaging surfaces 206 at the outer edge of the section 202. Section 204 includes a convex, curved tissue engaging surface 208. FIGS. 10 and 11 illustrate the use of the instrument by a practitioner to treat the soft tissue of a person.

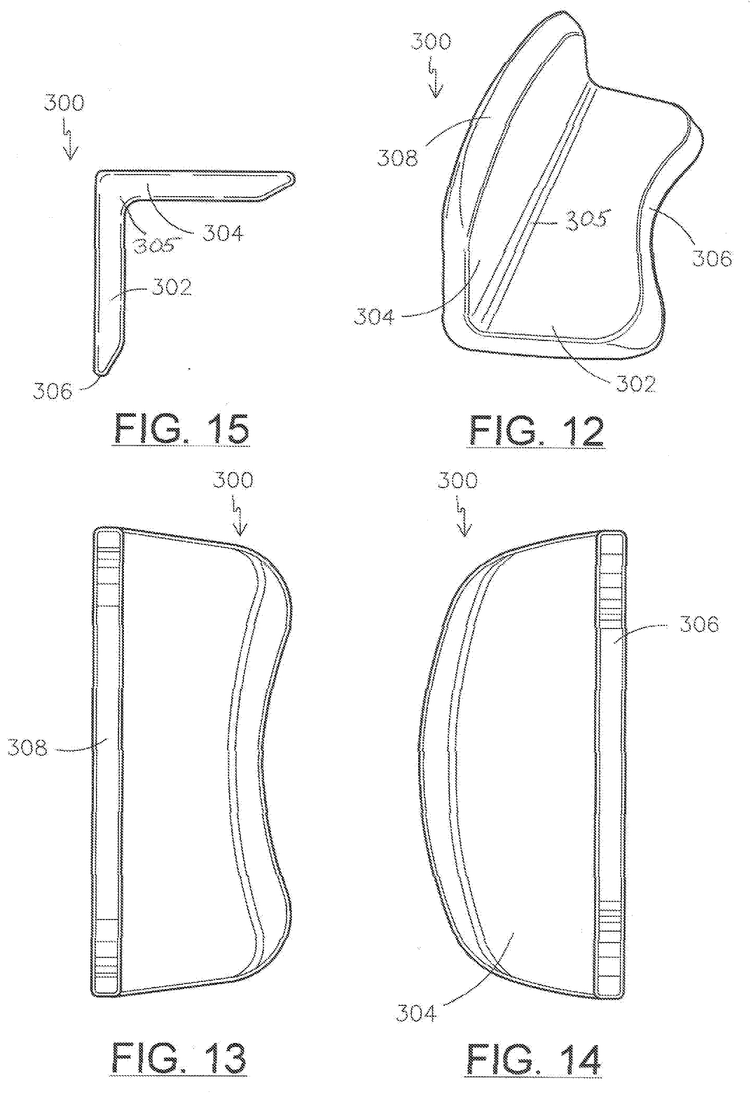

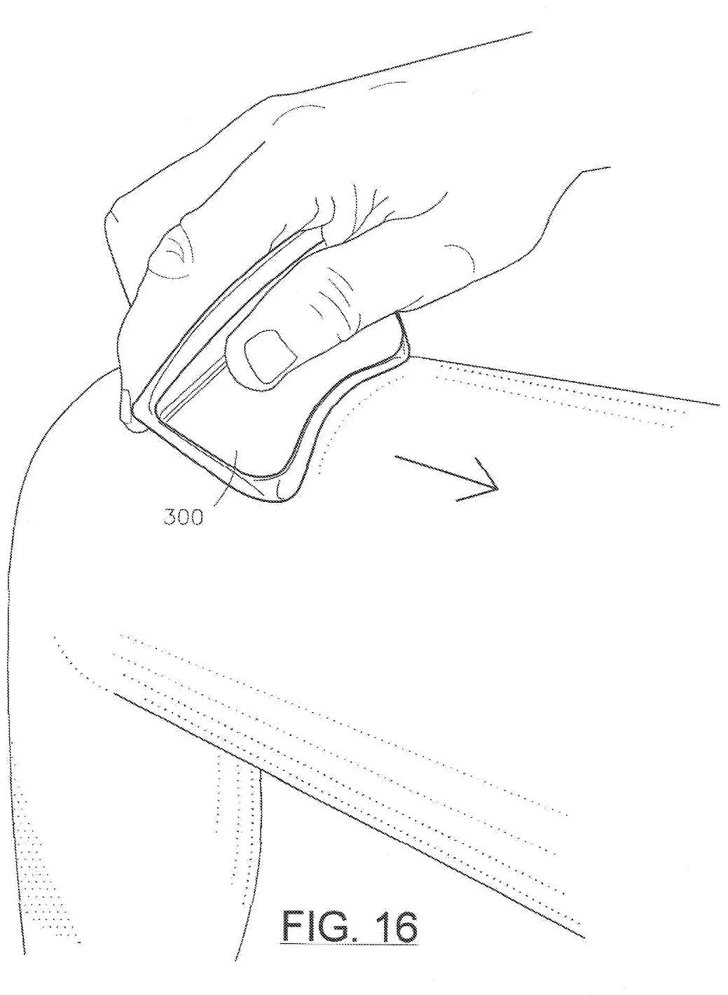

FIGS. 12 to 15 illustrate still another embodiment of a soft tissue mobilization instrument 300. Similar to the embodiments described above, the instrument 300 includes sections 302 and 304 connected at 90 degrees along common, inner longitudinal edges 305. Section 302 includes curved, concave tissue engaging surfaces 306 at the outer edge of the section 302. Section 304 includes a convex, curved tissue engaging surface 308. FIG. 16 illustrates the use of the instrument by a practitioner to treat the soft tissue of a person.

Other various angular configurations of an instrument in accordance with the present invention may be used to provide a shape that allows for an improved grip for the practitioner, particularly when working in and around the curves and nooks of the body.

It will be appreciated that all the outer edges of the instruments have a soft radius thereby eliminating sharp edges that may cause discomfort or injury to a person being treated.

Whereas, the preferable edges of each working section are shown concave and convex, the present invention is not so limited and a variety of different shapes may be used to accommodate various treatments and/or body shapes in keeping within the spirit and scope of the present invention as defined in the following claims.

1. A manipulation instrument for use by a practitioner to treat the soft tissue of a person comprising:
two generally flat planar sections each having an outer tissue engaging surface; a first of said planar sections being located in a first spatial plane at a first angle; a second of said planar sections being located in a second spatial plane at a second angle; said first spatial plane and said second spatial plane being oriented at 90 degrees each with respect to the other;
each section being defined as having length and width; said length being approximately three times larger than said width; each section further including an inner longitudinal edge; a connection formed by the inner longitudinal edges of each section interconnecting said first and second planar sections.

2. The instrument of claim 1 wherein said tissue engaging surface of each section is curved.

3. The instrument of claim 2 wherein at least one tissue engaging surface is convex.

4. The instrument of claim 2 wherein at least one tissue engaging surface is concave.

5. The instrument of claim 2 wherein at least one tissue engaging surface has a parabolic shape.

6. A manipulation instrument for use by a practitioner to treat the soft tissue of a person comprising:
two generally flat planar sections each defined as having length and width; the length being defined by a tissue engaging surface at an outer location of each section; a longitudinal edge at an inner location of each section; an end edges at opposite ends of each section; the length of each section being approximately three times larger than the width of each section; each section further including an inner longitudinal edge; a connection formed by the inner longitudinal edges of each section interconnecting said first and second planar sections;
a first of said planar sections being located in a first spatial plane at a first angle; a second of said planar sections being located in a second spatial plane at a second angle; said first spatial plane and said second spatial plane being oriented at 90 degrees each with respect to the other.

7. A manipulation instrument for use by a practitioner to treat the soft tissue of a person consisting of:
two generally flat planar sections each having an outer tissue engaging surface; a first of said planar sections being located in a first spatial plane at a first angle; a second of said planar sections being located in a second spatial plane at a second angle; said first spatial plane and said second spatial plane being oriented at 90 degrees each with respect to the other;
each section being defined as having length and width; said length being approximately three times larger than said width; each section further including an inner longitudinal edge; a connection formed by the inner longitudinal edges of each section interconnecting said first and second planar sections.
